(19) United States
(12) Patent Application Publication
(10) Pub. No.: US 2013/0328979 A1
(43) Pub. Date: Dec. 12, 2013

(54) INK SET FOR INKJET RECORDING, RECORDING METHOD, AND COLORED MATERIAL PRODUCED USING THE INK SET

(71) Applicants: Shinsuke Shimizu, Tokyo (JP); Tadahiko Tabe, Tokyo (JP); Akio Kuwahara, Tokyo (JP)

(72) Inventors: Shinsuke Shimizu, Tokyo (JP); Tadahiko Tabe, Tokyo (JP); Akio Kuwahara, Tokyo (JP)

(73) Assignee: NIPPON KAYAKU KABUSHIKI KAISHA, Tokyo (JP)

(21) Appl. No.: 13/988,894

(22) PCT Filed: Nov. 25, 2011
(86) PCT No.: PCT/JP2011/077194

§ 371 Date: Aug. 9, 2013

(30) Foreign Application Priority Data
Nov. 26, 2010 (JP) 2010-263112

(51) Int. Cl. C09D 11/00; B41J 2/21

(52) U.S. Cl. CPC C09D 11/328; C09D 11/40; B41J 2/2107
USPC 347/100; 106/31.47; 428/195.1

(57) ABSTRACT

An ink set for inkjet recording, which has excellent water resistance and light resistance in the hue range of yellow-orange-magenta. The ink set includes two-color ink compositions, i.e., a) a magenta ink composition and b) an yellow ink composition, each of which includes a dye, water and a water-soluble organic solvent, wherein the magenta ink composition a) contains a compound produced by sulfonating a compound represented by the formula (1), a salt of the compound, or a mixture thereof as a coloring agent.

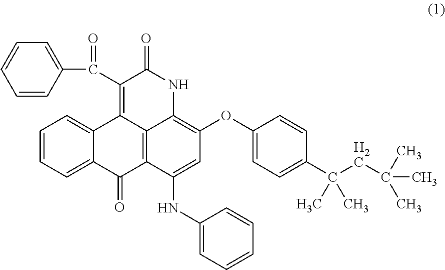 [SMILES: CC(C)(C)CC(C)(C)c1ccc(Oc2cc(Nc3ccccc3)c3c4c(c(C(=O)c5ccccc5)c(=O)[nH]c24)-c2ccccc2C3=O)cc1]

### TECHNICAL FIELD

The present invention relates to an ink for inkjet recording and an inkjet recording method using the same. More specifically, the present invention relates to a dye-ink set for inkjet recording that is superior in water resistance and light resistance, and to an inkjet recording method using the same, and in particular, relates to an ink set for inkjet recording that is superior in water resistance and light resistance in the hue range of yellow-orange-magenta and that exhibits favorable discharge stability, and an inkjet recording method using the same.

### BACKGROUND ART

In a recording method using an inkjet printer, which is one typical method among a variety of color recording methods, recording is executed by generating ink droplets, which adhere to any of a variety of record-receiving materials (for example, paper, film, fabric, and the like). According to this method, a recording head is not brought into direct contact with the record-receiving material; therefore, noise generation can be reduced, thus achieving silent recording. In addition, because the features of reduced size and increased speed are readily achievable, there has been rapid progress in recent years. Accordingly, great advancement of the method hereafter is expected.

Aqueous inks prepared by dissolving a water-soluble dye in an aqueous medium have been used as conventional inks for fountain pens, felt pens, and the like, and as inks for inkjet printing. A water-soluble organic solvent is generally added to these aqueous inks in order to prevent pen tips or ink discharge nozzles from clogging with ink. In addition, for these inks what is demanded are the ability to generate a recorded image with sufficient density, the probability of avoiding occurrence of clogging at pen tips and nozzles, favorable drying characteristics on the record-receiving materials, suppression of bleeding, superior storage stability, and the like. Furthermore, water-soluble dyes for use must have high solubility, particularly in water, and high solubility in water-soluble organic solvents added to the inks. Moreover, it is desirable for the formed images to have image-fastness properties such as water resistance and light resistance, as well as color reproducibility. In addition, it is important to have balance of each color as well as simply high image-fastness properties.

In recent years, along with the development of inkjet technology, the improvement of the printing speed of inkjet printing has been remarkable. Accordingly, there is a trend afoot to employ an inkjet printer like a laser printer, using electronic toner to print a document on plain paper, which is a major application in an office environment. Since an inkjet printer has advantages in that it can use any kind of recording paper and the cost of the machine is relatively cheap, the spread of such inkjet printers has proceeded in particular in small to medium-sized office environments such as a SOHO. As described above, in the case where an inkjet printer is used for printing on plain paper, there is a tendency, among qualities required for printed matter, for hue or water resistance to become very important.

A method of using a pigment ink has been proposed in order to provide such performance. However, since a pigment ink is not a solution, but a dispersion liquid prepared by dispersing a solid pigment, when the pigment ink is used, problems in that the storage stability of the ink is degraded and the nozzle of the recording head is clogged occur readily as compared with a dye ink. In addition, when a pigment ink is used, in many cases, the low abrasion resistance of the printed image is a problem. In the case of a dye ink, since the dye that is the coloring matter is dissolved in the ink, it is relatively difficult to generate the problems that occur in the pigment ink described above. However, in general, the water resistance of a dye ink in particular is significantly lower than with a pigment ink, and therefore the improvement thereof is strongly required.

Further, in addition to the aforementioned performance properties, the performance required for an ink set for the purpose of printing on plain paper may include color reproducibility (coloring properties, that is, chroma or lightness), storage stability, ozone resistance (gas resistance), moisture resistance, and the like, but in any case there are still no proposed ink sets that fully satisfy any one of these performances properties.

In order to solve the problems described above, there are ink sets disclosed in Patent Documents 1 to 5 as examples. An ink set for inkjet recording that is a combination of yellow, magenta, and cyan dye inks has been proposed. However, the inks disclosed in Patent Documents 1 to 3 have insufficient water resistance and light resistance in the hue range of yellow-orange-magenta, include a direct dye, an acidic dye, and a reactive dye as a coloring agent, and also fail to perform as an ink set having sufficient water resistance and light resistance in such a hue range.

C.I. Direct Yellow 86, 132, Acid Yellow 110, and the like, for example, which are disclosed in Patent Documents 1 to 12, are known as yellow coloring agents suitable for a dye ink for inkjet recording. In addition, C.I. Direct Red 227, C.I. Acid Red 52, a compound obtained by sulfonating a compound represented by the formula (1) of the present application, a compound represented by the formula (2) of the present application, and the like, for example, which are disclosed in Patent Documents 1 to 6 and 13 are known as magenta coloring agents. However, no ink set having sufficient performance for water resistance and light resistance has been proposed.
Patent Document 1: Japanese Unexamined Patent Application, Publication No. 2000-109737
Patent Document 2: Japanese Unexamined Patent Application, Publication No. 2001-192591
Patent Document 3: Japanese Unexamined Patent Application, Publication No. 2001-294786
Patent Document 4: Japanese Unexamined Patent Application, Publication No. H9-76629
Patent Document 5: Japanese Unexamined Patent Application, Publication No. H10-329403
Patent Document 6: Japanese Unexamined Patent Application, Publication No. H11-199815
Patent Document 7: Japanese Unexamined Patent Application, Publication No. 2001-115075
Patent Document 8: Japanese Unexamined Patent Application, Publication No. 2003-128965
Patent Document 9: Japanese Unexamined Patent Application, Publication No. 2003-138169
Patent Document 10: Japanese Unexamined Patent Application, Publication No. 2003-238870
Patent Document 11: Japanese Unexamined Patent Application, Publication No. 2002-348504
Patent Document 12: Japanese Unexamined Patent Application, Publication No. 2004-051776
Patent Document 13: Japanese Patent Publication No. 3957450

### DISCLOSURE OF THE INVENTION

### Problems to be Solved by the Invention

An object of the present invention is to provide a dye-ink set for inkjet recording that is superior in water resistance and light resistance in the hue range of yellow-orange-magenta and that is also favorable in discharge stability.

### Means for Solving the Problems

The present inventors thoroughly investigated in order to solve the foregoing problems, and consequently found that an ink set for inkjet recording including at least two inks of magenta and yellow, each containing a specific dye as a coloring agent, is superior in water resistance and light resistance, particularly in the hue range of yellow-orange-magenta, and is also superior in discharge stability. Thus, the present invention was accomplished. More specifically, the present invention relates to the following aspects.

An ink set for inkjet recording according to a first aspect includes two ink compositions, each of a different color, of a) a magenta-ink composition and b) a yellow-ink composition, each containing a dye, water, and a water-soluble organic solvent, in which the magenta-ink composition a) contains a compound obtained by sulfonating a compound represented by the following formula (1), a salt thereof, or a mixture thereof as a coloring agent:

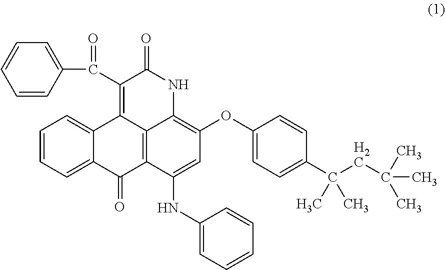 [SMILES: CC(C)(C)CC(C)(C)c1ccc(Oc2cc(Nc3ccccc3)c3c4c(c(C(=O)c5ccccc5)c(=O)[nH]c24)-c2ccccc2C3=O)cc1]

According to a second aspect, the magenta-ink composition a) includes a compound represented by the following formula (2), a salt thereof, or a mixture thereof as a coloring agent in the ink set for inkjet recording according to the first aspect:

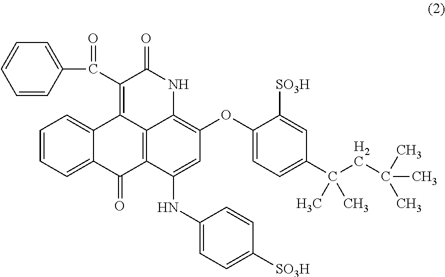 [SMILES: CC(C)(C)CC(C)(C)c1ccc(Oc2cc(Nc3ccc(S(=O)(=O)O)cc3)c3c4c(c(C(=O)c5ccccc5)c(=O)[nH]c24)-c2ccccc2C3=O)c(S(=O)(=O)O)c1]

According to a third aspect, the content of the compound represented by the above formula (2), a salt thereof, or a mixture thereof is 80% by mass or more in the coloring agent of the magenta-ink composition a) in the ink set for inkjet recording according to the second aspect.

According to a fourth aspect, the yellow-ink composition b) includes C.I. Direct Yellow 132 as a coloring agent in the ink set for inkjet recording according to any one of the first to third aspects.

According to a fifth aspect, the yellow-ink composition b) includes C.I. Acid Yellow 110 as a coloring agent in the ink set for inkjet recording according to any one of the first to third aspects.

According to a sixth aspect, the yellow-ink composition b) includes both C.I. Direct Yellow 132 and C.I. Acid Yellow 110 as coloring agents in the ink set for inkjet recording according to any one of the first to third aspects.

According to a seventh aspect, a blend ratio of C.I. Direct Yellow 132 to C.I. Acid Yellow 110 as a coloring agent included in the yellow-ink composition b) is 30/70 to 90/10 on a mass basis in the ink set for inkjet recording according to the sixth aspect.

According to an eighth aspect, a blend ratio of C.I. Direct Yellow 132 to C.I. Acid Yellow 110 as a coloring agent included in the yellow-ink composition b) is 40/60 to 60/40 on a mass basis in the ink set for inkjet recording according to the sixth aspect.

According to a ninth aspect, the total content of the coloring agent is 0.5 to 10% by mass in the total mass of the magenta-ink composition a), and the total content of the coloring agent is 0.5 to 10% by mass in the total mass of the yellow-ink composition b) in the ink set for inkjet recording according to any one of the first to eighth aspects.

According to a tenth aspect, the total content of the coloring agent is 2 to 6% by mass in the total mass of the magenta-ink composition a), and the total content of the coloring agent is 2 to 6% by mass in the total mass of the yellow-ink composition b) in the ink set for inkjet recording according to any one of the first to eighth aspects.

An inkjet recording method according to an eleventh aspect includes executing recording by using the ink set for inkjet recording according to any one of the first to tenth aspects and discharging ink droplets of each ink of the ink set in response to recording signals to cause the droplets to adhere to a record-receiving material.

According to a twelfth aspect, the record-receiving material is a communication sheet in the inkjet recording method according to the eleventh aspect.

A colored material according to a thirteenth aspect is obtained by coloring with the ink set for inkjet recording according to any one of the first to tenth aspects.

According to a fourteenth aspect, the coloring is carried out by using an inkjet printer in the colored material according to the thirteenth aspect.

An inkjet printer according to a fifteenth aspect is equipped with a vessel including each ink composition included in the ink set for inkjet recording according to any one of the first to tenth aspect.

### Effects of the Invention

According to the present invention, an ink set and a recording method using the ink set can be provided, in which the ink set is superior in water resistance and light resistance, particularly in the hue range of yellow-orange-magenta, and is also superior in discharge stability. In addition, it is expected that the ink set may be also superior in color reproducibility, storage stability, ozone resistance, moisture resistance, and the like in comparison with the foregoing excellent properties.

### BRIEF DESCRIPTION OF THE DRAWINGS

Hereinafter, the present invention will be described in detail. In addition, unless otherwise particularly stated in the present invention, acidic functional groups such as sulfo groups and carboxy groups are represented in the form of their free acids. Moreover, unless otherwise particularly stated in the following present specification, the “coloring matter or a salt thereof” included in each ink composition that constitutes the ink set of the present invention may be expediently referred to as “coloring matter” including both the coloring matter and a salt thereof, and the “compound, a salt thereof, or a mixture thereof” may be expediently referred to as a “compound” that includes them.

The ink set for use in the inkjet recording method of the present invention includes at least two ink compositions: a) a magenta-ink composition and b) a yellow-ink composition, each containing a compound having a specific structure.

By including these two ink compositions, each having a different color, the ink set of the present invention is superior in water resistance and discharge stability, and unprecedented water resistance and light resistance are realized, particularly in the hue range of yellow-orange-magenta.

The magenta-ink composition a) included in the ink set of the present invention includes a compound obtained by sulfonating a compound represented by the above formula (1), a salt thereof, or a mixture thereof, as a coloring agent. By including the compound, an ink set having superior water resistance and light resistance, as well as very favorable ink discharge stability, is obtained. In addition, water resistance and light resistance may be improved, particularly in the hue range of yellow-orange-magenta.

In addition, when a magenta-ink composition a) includes, as a coloring agent, a compound represented by the above formula (2), a salt thereof, or a mixture thereof in 80% by mass or more in the coloring agent, an ink set may have more superior water resistance and light resistance, as well as very favorable ink discharge stability.

It is preferable that the total content of a compound obtained by sulfonating a compound represented by the formula (1), a salt thereof, or a mixture thereof be 0.5 to 10% by mass in the total mass of the magenta-ink composition a). When the total content is less than 0.5% by mass, a sufficient hue range may not be expressed, and when it is more than 10% by mass, there may be problems with storage stability and discharge stability. From a similar viewpoint, it is more preferable that the total content be 2 to 6% by mass.

In addition, the magenta-ink composition a) used in the ink set of the present invention may include other coloring agents in a range in which the effects of the present invention are not impaired, for the purpose of adjustment of color tone.

As a coloring agent used to adjust color tone with respect to orange dyes, for example, specific examples of a reactive dye may include C.I. Reactive Orange 5, 9, 12, 35, 45, 99, and the like. Furthermore, specific examples of an acidic dye may include C.I. Acid Orange 3, 7, 8, 10, 19, 24, 51, 56, 67, 74, 80, 86, 87, 88, 89, 94, 95, 107, 108, 116, 122, 127, 140, 142, 144, 149, 152, 156, 162, 166, 168, and the like. Moreover, specific examples of a direct dye may include C.I. Direct Orange 17, 26, 102, and the like.

With respect to red dyes, specific examples of the reactive dye may include C.I. Reactive Red 3, 3:1, 4, 13, 24, 29, 31, 33, 125, 151, 206, 218, 226, 245, and the like. In addition, specific examples of the acidic dye may include C.I. Acid Red 1, 6, 8, 9, 13, 18, 27, 35, 37, 52, 54, 57, 73, 82, 88, 97, 97:1, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, 415, and the like. Furthermore, specific examples of the direct dye may include C.I. Direct Red 2, 4, 6, 9, 17, 23, 26, 28, 31, 39, 54, 55, 57, 62, 63, 64, 65, 68, 72, 75, 76, 79, 80, 81, 83, 83:1, 84, 89, 92, 95, 99, 111, 141, 173, 180, 184, 207, 211, 212, 214, 218, 221, 223, 224, 225, 226, 227, 232, 233, 240, 241, 242, 243, 247, and the like.

With respect to violet dyes, specific examples of the reactive dye may include C.I. Reactive Violet 1, 24, and the like. Specific examples of the acidic dye may include C.I. Acid Violet 17, 19, 21, 42, 43, 47, 48, 49, 54, 66, 78, 90, 97, 102, 109, 126, and the like. Furthermore, specific examples of the direct dye may include C.I. Direct Violet 7, 9, 47, 48, 51, 66, 90, 93, 94, 95, 98, 100, 101, and the like.

Additionally, other dyes may be further included. The blend ratio of a compound obtained by sulfonating a compound represented by the above formula (1), a salt thereof, or a mixture thereof and the orange dye, red dye, or violet dye as another coloring agent is typically 50/50 to 100/0, preferably 75/25 to 100/0, and more preferably 90/10 to 100/0 on a mass basis.

The coloring agent contained in the yellow-ink composition b) included in the ink set of the present invention is not particularly limited, and a general yellow dye may be used. However, C.I. Direct Yellow 132 or C.I. Acid Yellow 110 is particularly preferably used, and thereby an ink set more markedly exhibiting the effects of the present invention may be provided. In addition, a case of using C.I. Direct Yellow 132 with C.I. Acid Yellow 110 may be more preferable, and thereby water resistance and light resistance may be further improved in the hue range of yellow-orange-magenta.

The total content of the coloring agent in the total mass of the yellow-ink composition b) is preferably 0.5 to 10% by mass. When the total content is less than 0.5% by mass, sufficient range of a hue may be not expressed, whereas when the total content is greater than 10% by mass, a problem of storage stability or discharge stability may occur. From a similar viewpoint, the total content is more preferably 2 to 6% by mass.

Also, the yellow-ink composition b) used in the ink set of the present invention may include another coloring agent for the purpose of adjustment of color tone, in a range in which the effects of the present invention are not impaired.

As a coloring agent used for adjusting color tone, for example, with respect to yellow dyes, specific examples of the reactive dye may include C.I. Reactive Yellow 2, 3, 18, 81, 84, 85, 95, 99, 102, and the like. Moreover, specific examples of the acidic dye may include C.I. Acid Yellow 1, 3, 11, 17, 18, 19, 23, 25, 36, 38, 40, 40:1, 42, 44, 49, 59, 59:1, 61, 65, 72, 73, 79, 99, 104, 110, 159, 169, 176, 184, 193, 200, 204, 207, 215, 219, 219:1, 220, 230, 232, 235, 241, 242, 246, and the like. Furthermore, specific examples of the direct dye may include C.I. Direct Yellow 8, 11, 12, 21, 28, 33, 39, 44, 49, 50, 85, 86, 87, 88, 89, 98, 100, 110, 144, 146, and the like.

With respect to orange dyes, specific examples of the reactive dye may include C.I. Reactive Orange 5, 9, 12, 35, 45, 99, and the like. In addition, specific examples of the acidic dye may include C.I. Acid Orange 3, 7, 8, 10, 19, 24, 51, 56, 67, 74, 80, 86, 87, 88, 89, 94, 95, 107, 108, 116, 122, 127, 140, 142, 144, 149, 152, 156, 162, 166, 168, and the like. Furthermore, specific examples of the direct dye may include C.I. Direct Orange 17, 26, 102, and the like.

Additionally, other dyes may be further included. In the case of using C.I. Direct Yellow 132, C.I. Acid Yellow 110, or a mixture thereof as a coloring agent, the blend ratio of the coloring agent to the yellow dye or orange dye as the other coloring agent is typically 50/50 to 100/0, preferably 75/25 to 100/0, and more preferably 90/10 to 100/0 on a mass basis.

In a preferred embodiment of the ink set for inkjet recording of the present invention, there are cases in which the magenta-ink composition a) includes a compound obtained by sulfonating a compound represented by the above formula (1), a salt thereof, or a mixture thereof, and the yellow-ink composition b) includes C.I. Direct Yellow 132 or C.I. Acid Yellow 110. In addition, more preferably, there are cases that the magenta-ink composition a) includes a compound represented by the above formula (1) and the yellow-ink composition b) includes both C.I. Direct Yellow 132 and C.I. Acid Yellow 110.

In addition, in regard to the content of a coloring agent, in a preferred embodiment of the ink set for inkjet recording of the present invention, there are cases in which the magenta-ink composition a) includes a compound obtained by sulfonating a compound represented by the above formula (1), a salt thereof, or a mixture thereof in an amount of 0.5 to 10% by mass, and the yellow-ink composition b) includes C.I. Direct Yellow 132 and/or C.I. Acid Yellow 110 in an amount of 0.5 to 10% by mass. Furthermore, more preferably, there are cases in which the magenta-ink composition a) includes a compound obtained by sulfonating a compound represented by the above formula (1), a salt thereof, or a mixture thereof in an amount of 2 to 6% by mass, and the yellow-ink composition b) includes C.I. Direct Yellow 132 and/or C.I. Acid Yellow 110 in an amount of 2 to 6% by mass.

In addition, in the case in which C.I. Direct Yellow 132 is used with C.I. Acid Yellow 110, the blend ratio is preferably 30/70 to 90/10 and more preferably 40/60 to 60/40 on a mass basis.

The ink set of the present invention can realize full-color printing by providing an ink set that includes four ink compositions, each of a different color, in which cyan- and black-ink compositions are included in addition to the two ink compositions of magenta and yellow. Coloring agents contained in the cyan- and black-ink compositions are not particularly limited, and well-known coloring agents may be used; however, dyes are more preferred than pigments, and direct dyes are still more preferred.

With respect to the coloring agent contained in the cyan-ink composition that may be used when the ink set of the present invention is used as an ink set that includes four ink compositions, each of a different color, specific examples of the reactive dye may include C.I. Reactive Blue 2, 5, 10, 13, 14, 15, 15:1, 49, 63, 71, 72, 75, 162, 176, and the like. In addition, specific examples of the acidic dye may include C.I. Acid Blue 1, 7, 9, 15, 23, 25, 40, 61:1, 62, 72, 74, 80, 83, 90, 92, 103, 104, 112, 113, 114, 120, 127, 127:1, 128, 129, 138, 140, 142, 156, 158, 171, 182, 185, 193, 199, 201, 203, 204, 205, 207, 209, 220, 221, 224, 225, 229, 230, 239, 249, 258, 260, 264, 277:1, 278, 279, 280, 284, 290, 296, 298, 300, 317, 324, 333, 335, 338, 342, 350, and the like. Furthermore, specific examples of the direct dye may include C.I. Direct Blue 1, 15, 22, 25, 41, 76, 77, 80, 86, 87, 90, 98, 106, 108, 120, 158, 163, 168, 199, 200, 201, 202, 226, and the like. Of these, C.I. Acid Blue 249 is preferred. Moreover, the content of the coloring agent in the total mass of the cyan-ink composition is typically 0.5 to 10% by mass, and preferably 2 to 6% by mass.

With respect to the coloring agent contained in the black-ink composition that may be used when the ink set of the present invention is used as an ink set that includes four ink compositions, each of a different color, specific examples of the reactive dye may include C.I. Reactive Black 1, 8, 23, 39, and the like. In addition, specific examples of the acidic dye may include C.I. Acid Black 1, 2, 3, 24, 24:1, 26, 31, 50, 52, 52:1, 58, 60, 63, 107, 109, 112, 119, 132, 140, 155, 172, 187, 188, 194, 207, 222, and the like, and C.I. Food Black 1, 2, and the like. Additionally, specific examples of the direct dye may include C.I. Direct Black 17, 19, 22, 31, 32, 51, 62, 71, 74, 112, 113, 154, 168, 195, and the like. Of these, C.I. Food Black 2, and C.I. Direct Black 19 and 168 are preferred. Further, the content of the coloring agent in the total mass of the black-ink composition is typically 0.5 to 10% by mass, and preferably 2 to 6% by mass.

In the black-ink composition, a mixed dye may be also used as a coloring agent, in which the mixed dye includes a blue dye as a principal component and is blended with orange and red dyes. Moreover, other dyes may be further included in the black-ink composition for the purpose of adjusting color tone.

With respect to the orange dye as a coloring agent blended in the black-ink composition, specific examples of the reactive dye may include C.I. Reactive Orange 5, 9, 12, 35, 45, 99, and the like. In addition, specific examples of the acidic dye may include C.I. Acid Orange 3, 7, 8, 10, 19, 24, 51, 56, 67, 74, 80, 86, 87, 88, 89, 94, 95, 107, 108, 116, 122, 127, 140, 142, 144, 149, 152, 156, 162, 166, 168, and the like. Moreover, specific examples of the direct dye may include C.I. Direct Orange 17, 26, 102, and the like.

With respect to brown dyes, specific examples of the reactive dye may include C.I. Reactive Brown 2, 8, 9, 17, 33, and the like. In addition, specific examples of the acidic dye may include C.I. Acid Brown 2, 4, 13, 14, 19, 28, 44, 123, 224, 226, 227, 248, 282, 283, 289, 294, 297, 298, 301, 355, 357, 413, and the like.

With respect to red dyes, specific examples of the reactive dye may include C.I. Reactive Red 3, 3:1, 4, 13, 24, 29, 31, 33, 125, 151, 206, 218, 226, 245, and the like. In addition, specific examples of the acidic dye may include C.I. Acid Red 1, 6, 8, 9, 13, 18, 27, 35, 37, 52, 54, 57, 73, 82, 88, 97, 97:1, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, 415, and the like. Moreover, specific examples of the direct dye may include C.I. Direct Red 2, 4, 6, 9, 17, 23, 26, 28, 31, 39, 54, 55, 57, 62, 63, 64, 65, 68, 72, 75, 76, 79, 80, 81, 83, 83:1, 84, 89, 92, 95, 99, 111, 141, 173, 180, 184, 207, 211, 212, 214, 218, 221, 223, 224, 225, 226, 227, 232, 233, 240, 241, 242, 243, 247, and the like.

With respect to violet dyes, specific examples of the reactive dye may include C.I. Reactive Violet 1, 24, and the like. In addition, specific examples of the acidic dye may include C.I. Acid Violet 17, 19, 21, 42, 43, 47, 48, 49, 54, 66, 78, 90, 97, 102, 109, 126, and the like. Moreover, specific examples of the direct dye may include C.I. Direct Violet 7, 9, 47, 48, 51, 66, 90, 93, 94, 95, 98, 100, 101, and the like.

With respect to blue dyes, specific examples of the reactive dye may include C.I. Reactive Blue 2, 5, 10, 13, 14, 15, 15:1, 49, 63, 71, 72, 75, 162, 176, and the like. In addition, specific examples of the acidic dye may include C.I. Acid Blue 1, 7, 9, 15, 23, 25, 40, 61:1, 62, 72, 74, 80, 83, 90, 92, 103, 104, 112, 113, 114, 120, 127, 127:1, 128, 129, 138, 140, 142, 156, 158, 171, 182, 185, 193, 199, 201, 203, 204, 205, 207, 209, 220, 221, 224, 225, 229, 230, 239, 249, 258, 260, 264, 277:1, 278, 279, 280, 284, 290, 296, 298, 300, 317, 324, 333, 335, 338, 342, 350, and the like. Furthermore, specific examples of the direct dye may include C.I. Direct Blue 1, 15, 22, 25, 41, 76, 77, 80, 86, 87, 90, 98, 106, 108, 120, 158, 163, 168, 199, 200, 201, 202, 226, and the like.

With respect to green dyes, specific examples of the reactive dye may include C.I. Reactive Green 5, 8, 19, and the like. In addition, specific examples of the acidic dye may include C.I. Acid Green 5, 9, 12, 16, 19, 20, 25, 27, 28, 40, 43, 56, 73, 81, 84, 104, 108, 109, and the like.

In particular, a blend of orange, red, and blue dyes is preferred. Also, the total content of the coloring agent in the total mass of the black-ink composition may be within the aforementioned range including these coloring agents that may be blended.

As the coloring agent contained in the black-ink composition that may be used when the ink set of the present invention is used as the ink set including the four ink compositions, each of a different color, a black pigment may be also used. The black pigment is preferably a carbon black pigment such as furnace black, lamp black, acetylene black, or channel black. Specific examples of the carbon black may include Raven 760 ULTRA, Raven 780 ULTRA, Raven 790 ULTRA, Raven 1060 ULTRA, Raven 1080 ULTRA, Raven 1170, Raven 1190 ULTRA II, Raven 1200, Raven 1250, Raven 1255, Raven 1500, Raven 2000, Raven 2500 ULTRA, Raven 3500, Raven 5000 ULTRA II, Raven 5250, Raven 5750, and Raven 7000 (manufactured by Columbia Carbon Co., Ltd); Monarch 700, Monarch 800, Monarch 880, Monarch 900, Monarch 1000, Monarch 1100, Monarch 1300, Monarch 1400, Regal 1330R, Regal 1400R, Regal 1660R, and Mogul L (manufactured by Cabot Corporation); Color Black FW1, Color Black FW2, Color Black FW2V, Color Black FW200, Color Black S150, Color Black 5160, Color Black 5170, Printex 35, Printex U, Printex V, Printex 140U, Printex 140V, Special Black 4, Special Black 4A, Special Black 5, and Special Black 6 (manufactured by Dexa Co., Ltd.); MA7, MA8, MA100, MA600, MCF-88, No. 25, No. 33, No. 40, No. 47, No. 52, No. 900, and No. 2300 (manufactured by Mitsubishi Chemical Corporation); and the like.

In general, the pigment is preferably dispersed in an aqueous solvent by a dispersant. At this time, a water-soluble resin in which the water-soluble resin has an average molecular weight in the range of preferably 1,000 to 30,000, and more preferably 5,000 to 20,000, is employed as the dispersant used for the dispersion. In addition, the acid value thereof is in the range of preferably 50 to 500, and more preferably 80 to 300. Specific examples of such a dispersant may include block copolymers, random copolymers, and graft copolymers or salts thereof, consisting of at least two or more monomers selected from, for example, styrene, a styrene derivative, vinylnaphthalene, a vinylnaphthalene derivative, acrylic acid, an acrylic acid derivative, maleic acid, a maleic acid derivative, itaconic acid, an itaconic acid derivative, fumaric acid, a fumaric acid derivative, vinyl acetate, vinylpyrrolidone, acrylamide and a derivative thereof, and the like.

A resin used as the pigment dispersant is included in the range of preferably 0.1 to 5% by mass, and more preferably 0.1 to 2.5% by mass with respect to the total weight of the ink.

As a method of dispersing a pigment, a method using a sand mill (a beads mill), a roll mill, a ball mill, a paint shaker, an ultrasonic disperser, a Microfluidizer, or the like may be included. Of these, a sand mill (a beads mill) is preferably used. Furthermore, preparation of a pigment-dispersion liquid using a sand mill (a beads mill) is preferably carried out under conditions in which the bead filling rate is increased and beads having a small diameter (diameter of 0.01 mm to 1 mm) are used. By carrying out dispersion under such conditions, the particle size of the dye can be reduced, and thus a dispersion solution having favorable dispersibility can be obtained. In addition, after preparation of the dispersion liquid, components having a larger particle size, such as pigment, may be preferably removed by filtration, centrifugal separation, or the like. Moreover, for the purpose of inhibiting bubbling and the like during preparation of the dispersion liquid, an anti-foaming agent such as a silicone-based or acetylene glycol-based defoaming agent may be added in a microscopic amount.

As a pigment, a self-dispersing pigment into which a hydrophilic functional group is introduced on the surface of the pigment may be used. Specific examples of the self-dispersing pigment may include BONJET CW-1 (manufactured by Orient Chemical Industries Co., Ltd.); Aquajet-Black 001 and Aquajet-Black 162 (manufactured by Tokai Carbon Co., Ltd.); Cabo-jet 200, Cabo-jet 300, and Cabo-jet 400 (manufactured by Cabot Corporation); and the like.

The ink set of the present invention may be provided as an ink set of 3 to 13 colors by adding ink compositions of light magenta, light yellow, light cyan, light black, orange, red, blue, violet, green, and the like, which may be generally referred to as “special colors,” if necessary, to the aforementioned ink set of two to four colors, that is, an ink set including ink compositions of cyan and black as well as of magenta and yellow, and thereby printing with more variable hue may be also realized.

As the ink compositions of the special colors described above, that is, light magenta, light yellow, light cyan, and light black, ink compositions prepared by reducing the concentrations of each of the dyes contained in the aforementioned four ink compositions, each of a different color, that is, each of the ink compositions of magenta, yellow, cyan, and black, may be used. The ratio of the dye concentration of the ink compositions of the special colors to the dye concentration of each of the four ink compositions, each of a different color, is typically no greater than ½, preferably no greater than ¼, and more preferably no greater than ⅙, whereas the lower limit may be about 1/20, and preferably 1/10, on a mass basis.

Furthermore, the coloring agents contained in the light-magenta ink, light-yellow ink, light-cyan ink, and light-black ink compositions are preferably the same as those contained in the four ink compositions, each of a different color, that is, magenta, yellow, cyan, and black, respectively.

As a coloring agent contained in the orange-ink composition that may be used when the ink set of the present invention is used as the ink set including the specific color-ink compositions, specific examples of the reactive dye may include C.I. Reactive Orange 5, 9, 12, 35, 45, 99, and the like. In addition, specific examples of the acidic dye may include C.I. Acid Orange 3, 7, 8, 10, 19, 24, 51, 56, 67, 74, 80, 86, 87, 88, 89, 94, 95, 107, 108, 116, 122, 127, 140, 142, 144, 149, 152, 156, 162, 166, 168, and the like. Moreover, specific examples of the direct dye may include C.I. Direct Orange 17, 26, 102, and the like. Of these, C.I. Reactive Orange 13 and C.I. Acid Orange 95 are preferred. Also, the content of the coloring agent in the total mass of the orange-ink composition is typically 0.5 to 10% by mass, and preferably 2 to 6% by mass.

As a coloring agent contained in the red-ink composition that may be used when the ink set of the present invention is used as the ink set that includes specific color-ink compositions, specific examples of the reactive dye may include C.I. Reactive Red 3, 3:1, 4, 13, 24, 29, 31, 33, 125, 151, 206, 218, 226, 245, and the like. In addition, specific examples of the acidic dye may include C.I. Acid Red 1, 6, 8, 9, 13, 18, 27, 35, 37, 52, 54, 57, 73, 82, 88, 97, 97:1, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, 415, and the like. Moreover, specific examples of the direct dye may include C.I. Direct Red 2, 4, 6, 9, 17, 23, 26, 28, 31, 39, 54, 55, 57, 62, 63, 64, 65, 68, 72, 75, 76, 79, 80, 81, 83, 83:1, 84, 89, 92, 95, 99, 111, 141, 173, 180, 184, 207, 211, 212, 214, 218, 221, 223, 224, 225, 226, 227, 232, 233, 240, 241, 242, 243, 247, and the like. Of these, C.I. Reactive Red 31 and C.I. Acid Red 249 are preferred. Also, the content of the coloring agent in the total mass of the red-ink composition is typically 0.5 to 10% by mass, and preferably 2 to 6% by mass.

As a coloring agent contained in the violet-ink composition that may be used when the ink set of the present invention is used as the ink set including the specific color-ink compositions, specific examples of the reactive dye may include C.I. Reactive Violet 1, 24, and the like. In addition, specific examples of the acidic dye may include C.I. Acid Violet 17, 19, 21, 42, 43, 47, 48, 49, 54, 66, 78, 90, 97, 102, 109, 126, and the like. Moreover, specific examples of the direct dye may include C.I. Direct Violet 7, 9, 47, 48, 51, 66, 90, 93, 94, 95, 98, 100, 101, and the like. Of these, C.I. Acid Violet 1 and 24 are preferred. Also, the content of the coloring agent in the total mass of the violet-ink composition is typically 0.5 to 10% by mass, and preferably 2 to 6% by mass.

As a coloring agent contained in the blue-ink composition that may be used when the ink set of the present invention is used as the ink set including the specific color-ink compositions, specific examples of the reactive dye may include C.I. Reactive Blue 2, 5, 10, 13, 14, 15, 15:1, 49, 63, 71, 72, 75, 162, 176, and the like. In addition, specific examples of the acidic dye may include C.I. Acid Blue 1, 7, 9, 15, 23, 25, 40, 61:1, 62, 72, 74, 80, 83, 90, 92, 103, 104, 112, 113, 114, 120, 127, 127:1, 128, 129, 138, 140, 142, 156, 158, 171, 182, 185, 193, 199, 201, 203, 204, 205, 207, 209, 220, 221, 224, 225, 229, 230, 239, 249, 258, 260, 264, 277:1, 278, 279, 280, 284, 290, 296, 298, 300, 317, 324, 333, 335, 338, 342, 350, and the like. Moreover, specific examples of the direct dye may include C.I. Direct Blue 1, 15, 22, 25, 41, 76, 77, 80, 86, 87, 90, 98, 106, 108, 120, 158, 163, 168, 199, 200, 201, 202, 226, and the like. Of these, C.I. Acid Blue 112 and C.I. Reactive Blue 49 are preferred. Also, the content of the coloring agent in the total mass of the blue-ink composition is typically 0.5 to 10% by mass, and preferably 2 to 6% by mass.

As a coloring agent contained in the green-ink composition that may be used when the ink set of the present invention is used as the ink set that includes specific color-ink compositions, specific examples of the reactive dye may include C.I. Reactive Green 5, 8, 19, and the like. In addition, specific examples of the acidic dye may include C.I. Acid Green 5, 9, 12, 16, 19, 20, 25, 27, 28, 40, 43, 56, 73, 81, 84, 104, 108, 109, and the like. Of these, C.I. Acid Green 5 is preferred. Also, the content of the coloring agent in the total mass of the green-ink composition is typically 0.5 to 10% by mass, and preferably 2 to 6% by mass.

The dye described above may also include a dye in the form of: powder; block; wet cake, or the like. Such reactive dyes are commercially available and have a variety of qualities such as powder for industrial dyeing, liquid products for textile printing, and dyes for use in inkjet textile printing; and their respective production method, purity, and the like vary. Some of them may contain an inorganic salt such as sodium chloride or sodium sulfate in a considerable amount (about 10% to 40% by mass in total mass of the product). Each ink composition that constitutes the ink set of the present invention is preferably prepared by using a material that includes as few impurities as possible in order to minimize adverse effects on storage stability and the discharge accuracy of inkjet printers. Additionally, water not especially purified and the like may contain metal ions such as calcium ions and magnesium ions; thus, ions and the like will be included in the ink composition even when the ink composition is prepared by using such water or the like, although the amount of the ions and the like may be slight. For the sake of simplicity, the aforementioned inorganic salts and metal ions together are referred to hereinafter as “inorganic impurities.” These inorganic impurities not only significantly degrade the storage stability and solubility of the dye in the ink composition and the like, but also may cause corrosion and abrasion of inkjet-printer heads. In order to eliminate these inorganic impurities, it is preferred that a well-known process such as an ultrafiltration process, a reverse-osmosis process, or an ion-exchange process be utilized to eliminate as much as possible the inorganic impurities included in the ink composition. The content of the inorganic impurities included in the total mass of the ink composition is generally no more than 1% by mass, preferably no more than 0.5% by mass, and more preferably no more than 0.1% by mass. Alternatively, the content may be 0% by mass, that is, at or below the detection limit of a detector.

The salts of the compounds obtained by sulfonating a compound represented by the above formula (1) are inorganic- or organic-cation salts. Specific examples of the inorganic salt may include alkali-metal salts, alkaline-earth metal salts, and ammonium salts. Preferred inorganic salts may include salts of lithium, sodium, or potassium, and ammonium salts. Furthermore, the organic-cation salt is exemplified by salts of the quaternary ammonium ion represented by the following formula (3), but is not limited thereto. Also, a free acid, a tautomer thereof, and a mixture of various types of the salts are acceptable. For example, a mixture of any combination, such as a mixture of a sodium salt with an ammonium salt, a mixture of a free acid with a sodium salt, and a mixture of a lithium salt, a sodium salt, and an ammonium salt may be used. Physical properties such as solubility may vary according to the type of the salt and, as necessary, the type of salt may be appropriately selected, or in the case in which a plurality of salts and the like are included, a mixture having physical properties to meet the needs can be obtained by changing the their proportion.

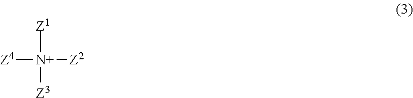

In the above formula (3), Z¹, Z², Z³, and Z⁴ each independently represents a group selected from the group consisting of a hydrogen atom, an alkyl group, a hydroxyalkyl group, and a hydroxyalkoxyalkyl group.

Specific examples of the alkyl group that may be represented by Z¹, Z², Z³, and Z⁴ in the above formula (3) may include methyl, ethyl, n-propyl, isopropyl, n-butyl, isobutyl, sec-butyl, tert-butyl and the like; specific examples of the hydroxyalkyl group may include hydroxy C1-C4 alkyl groups such as hydroxymethyl, hydroxyethyl, 3-hydroxypropyl, 2-hydroxypropyl, 4-hydroxybutyl, 3-hydroxybutyl, and 2-hydroxybutyl; and examples of the hydroxyalkoxyalkyl group may include hydroxy C1-C4 alkoxy C1-C4 alkyl groups such as hydroxyethoxymethyl, 2-hydroxyethoxyethyl, 3-hydroxyethoxypropyl, 2-hydroxyethoxypropyl, 4-hydroxyethoxybutyl, 3-hydroxyethoxybutyl and 2-hydroxyethoxybutyl. Of these, hydroxyethoxy C1-C4 alkyl is preferred. Particularly preferred examples may include a hydrogen atom; methyl; hydroxy C1-C4 alkyl groups such as hydroxymethyl, hydroxyethyl, 3-hydroxypropyl, 2-hydroxypropyl, 4-hydroxybutyl, 3-hydroxybutyl and 2-hydroxybutyl; and hydroxyethoxy C1-C4 alkyl groups such as hydroxyethoxymethyl, 2-hydroxyethoxyethyl, 3-hydroxyethoxypropyl, 2-hydroxyethoxypropyl, 4-hydroxyethoxybutyl, 3-hydroxyethoxybutyl and 2-hydroxyethoxybutyl.

Specific examples of combinations of Z¹, Z², Z³, and Z⁴ preferred as the compound represented by the above formula (3) are listed in the following Table 1.

TABLE 1

| Compound No. | Z¹ | Z² | Z³ | Z⁴ |
|---|---|---|---|---|
| 1-1 | H | CH3 | CH3 | CH3 |
| 1-2 | CH3 | CH3 | CH3 | CH3 |
| 1-3 | H | —C2H4OH | —C2H4OH | —C2H4OH |
| 1-4 | CH3 | —C2H4OH | —C2H4OH | —C2H4OH |
| 1-5 | H | —CH2CH(OH)CH3 | —CH2CH(OH)CH3 | —CH2CH(OH)CH3 |
| 1-6 | CH3 | —CH2CH(OH)CH3 | —CH2CH(OH)CH3 | —CH2CH(OH)CH3 |
| 1-7 | H | —C2H4OH | H | —C2H4OH |
| 1-8 | CH3 | —C2H4OH | H | —C2H4OH |
| 1-9 | H | —CH2CH(OH)CH3 | H | —CH2CH(OH)CH3 |
| 1-10 | CH3 | —CH2CH(OH)CH3 | H | —CH2CH(OH)CH3 |
| 1-11 | CH3 | —C2H4OH | CH3 | —C2H4OH |
| 1-12 | CH3 | —CH2CH(OH)CH3 | CH3 | —CH2CH(OH)CH3 |

In order to produce desired salts of the compounds obtained by sulfonating the compounds represented by the above formula (1) according to the present invention, a desired inorganic salt or organic-cation salt may be added, after a reaction, to the reaction solution to permit salting out, or a corresponding salt solution may be prepared by adding a mineral acid such as hydrochloric acid to isolate in the form of a free acid, followed by washing as necessary with water, acidic water, an aqueous organic medium, or the like to remove the inorganic salt, and thereafter neutralizing in an aqueous medium with a desired inorganic or organic base. Herein, the acidic water is exemplified by mineral acids such as sulfuric acid and hydrochloric acid, and by organic acids such as acetic acid dissolved in water to prepare an acidic solution. Moreover, the aqueous organic medium means an organic substance that contains water and that is miscible with water, as well as organic solvents in general that are miscible with water, and the like. Specific examples of the aqueous organic medium may include water-soluble organic solvents described later, and the like, but an organic substance not classified as a solvent in general can be also used as necessary as long as it is miscible with water. Examples of the organic substance not classified as a solvent in general may include urea, saccharides, and the like.

Examples of the inorganic salt may include alkali-metal salts such as lithium chloride, sodium chloride, and potassium chloride, and ammonium salts such as ammonium chloride and ammonium bromide. Examples of the organic-cation salt may include halogen salts of organic amines, and the like. Examples of the inorganic base may include hydroxides of alkali metals such as lithium hydroxide, sodium hydroxide, and potassium hydroxide, ammonium hydroxide, and carbonates of alkali metals such as lithium carbonate, sodium carbonate, and potassium carbonate, and the like. Examples of the organic base may include organic amines such as salts of quaternary ammoniums represented by the above formula (3), such as diethanolamine, triethanolamine, and the like, but are not limited thereto.

The ink composition that constitutes the ink set of the present invention will be described. The aqueous-ink composition that includes the compound obtained by sulfonating the compound represented by the above formula (1) according to the present invention is capable of dyeing a material composed of cellulose. In addition, other materials having a carbonamide bond can be dyed, and each ink composition that constitutes the ink set of the present invention may be broadly used in staining leathers, fabrics, papers, and the like. In addition, a representative method of using the compound according to the present invention may be an ink composition prepared by dissolving it in a liquid medium.

It is preferred that each ink composition that constitutes the ink set of the present invention have a viscosity at 25° C., as measured with an E-type viscometer, in the range of generally 3 to 20 mPa·s. Similarly, the surface tension of these ink compositions may preferably be in the range of generally 20 to 40 mN/m, as measured by the plate method. The viscosity of each of the ink compositions may be adjusted to an appropriate value of physical properties within the above ranges, with consideration for the amount of discharge, response speed, flight characteristics of the ink droplets, characteristics of the inkjet head, and the like of the printer used.

Each ink composition that constitutes the ink set of the present invention contains a water-soluble organic solvent. The water-soluble organic solvent has the function of a viscosity-adjusting agent or a drying inhibitor. Moreover, when the ink composition that constitutes the ink set of the present invention contains a reactive dye, it is preferred that the water-soluble organic solvent be nonreactive with the dye in the ink composition. Also, in order to prevent clogging at the nozzle in the inkjet printer, and the like, a water-soluble organic solvent having a high wetting effect is preferred. It is to be noted that in case the ink composition does not contain a reactive dye, it is not necessary to employ a water-soluble organic solvent that is nonreactive with the reactive dye.

Polyhydric alcohols, pyrrolidones, and the like may be given as examples of the water-soluble organic solvent described above. For example, C2-C6 polyhydric alcohols having two to three alcoholic hydroxyl groups, poly C2-C3 alkylene glycols having four or more repeating units and a molecular weight no higher than about 20,000, preferably liquid polyalkylene glycols, and the like, may be cited as examples of the polyhydric alcohols. Among these, C2-C3 alkylene glycols and pyrrolidones are preferred, the former being more preferred.

Specific examples of the water-soluble organic solvent may include: C2-C6 polyhydric alcohols having two to three alcoholic hydroxyl groups such as glycerin, 1,3-pentanediol, and 1,5-pentanediol; polyglyceryl ethers such as diglycerin and polyglycerin; polyoxy C2-C3 alkylene polyglyceryl ethers such as polyoxyethylene polyglyceryl ether and polyoxypropylene polyglyceryl ether; mono-, di-, or tri-C2-C3 alkylene glycols such as ethylene glycol, diethylene glycol, triethylene glycol, propylene glycol, and polyethylene glycol; poly C2-C3 alkylene glycols such as polyethylene glycol and polypropylene glycol; pyrrolidones such as 2-pyrrolidone and N-methyl-2-pyrrolidone; and the like. Among these, glycerin, diethylene glycol, propylene glycol, isopropyl alcohol, and 2-pyrrolidone are preferred.

The water-soluble organic solvent is used either alone or in combination.

Each ink composition that constitutes the ink set of the present invention may further contain, in addition to the aforementioned water-soluble organic solvent, agents for preparing inks such as, for example, a surfactant, a pH-adjusting agent, and a preservative fungicide. The surface tension of the ink compositions is preferably adjusted with a variety of surfactants, that is, anionic surfactants, cationic surfactants, amphoteric surfactants, nonionic surfactants, and the like.

Examples of the anionic surfactant may include alkylsulfocarboxylic acid salts, α-olefin sulfonic acid salts, polyoxyethylene alkyl ether acetic acid salts, N-acylamino acids or salts thereof, N-acylmethyltaurine salts, alkylsulfate polyoxyalkyl ether sulfuric acid salts, alkylsulfate polyoxyethylene alkyl ether phosphoric acid salts, rosin acid soap, castor oil sulfate ester salts, lauryl alcohol sulfate ester salts, alkylphenolic phosphate esters, alkylated phosphate esters, alkylarylsulfonic acid salts, diethyl sulfosuccinic acid salts, diethylhexyl sulfosuccinic acid salts, dioctyl sulfosuccinic acid salts, and the like.

Examples of the cationic surfactant may include 2-vinylpyridine derivatives, poly(4-vinylpyridine) derivatives, and the like.

Examples of the amphoteric surfactant may include lauryldimethylamino acetate betaine, 2-alkyl-N-carboxymethyl-N-hydroxyethylimidazolinium betaine, coconut oil fatty acid amidopropyldimethylamino acetate betaine, polyoctylpolyaminoethylglycine, imidazoline derivatives, and the like.

Examples of the nonionic surfactant may include: ether-based surfactants such as polyoxyethylene nonylphenyl ether, polyoxyethylene octylphenyl ether, polyoxyethylene dodecylphenyl ether, polyoxyethylene oleyl ether, polyoxyethylene lauryl ether and polyoxyethylene alkyl ether; ester-based surfactants such as polyoxyethylene oleate esters, polyoxyethylene distearate esters, sorbitan laurate, sorbitan monostearate, sorbitan monooleate, sorbitan sesquioleate, polyoxyethylene monooleate, and polyoxyethylene stearate; acetylene alcohol-based surfactants such as 2,4,7,9-tetramethyl-5-decyne-4,7-diol, 3,6-dimethyl-4-octyne-3,6-diol, and 3,5-dimethyl-1-hexin-3-ol; and the like. Other specific examples may include trade names Surfynol 104, 105PG50, 82, 420, 440, 465, 485, and Olfine STG, manufactured by Nissin Chemical Co., Ltd.; and the like. The surfactant is preferably of the Surfinol series, and more preferably Surfynol 104PG50 and Surfynol 440.

It is preferred that each ink composition that constitutes the ink set of the present invention further contain triethanolamine as a pH-adjusting agent. The content of triethanolamine in the total mass of each ink composition is typically 0.01 to 2% by mass, and preferably 0.05 to 1.0% by mass.

Furthermore, each ink composition that constitutes the ink set of the present invention may include an agent for preparing inks such as a preservative fungicide; a pH-adjusting agent other than triethanolamine; and the like if necessary. The sum of these agents for preparing inks may be typically about 0 to 10% by mass and preferably about 0.05 to 5% by mass relative to the total mass of the ink composition.

Examples of the preservative fungicide may include sodium dehydroacetate, sodium benzoate, sodium pyridinethione-1-oxide, zinc pyridinethione-1-oxide, 1,2-benzisothiazolin-3-one, 1-benzisothiazolin-3-one amine salts, and the like. Additionally, other specific examples may include Proxel GXL, manufactured by Avecia, Inc., and the like, a preferable example being Proxel GXL.

Examples of the pH-adjusting agent may include alkali hydroxides such as sodium hydroxide, potassium hydroxide, and lithium hydroxide; tertiary amines such as diethanolamine, dimethylethanolamine, and diethyl ethanolamine; tris(hydroxymethyl)aminomethane, and the like.

Each ink composition that constitutes the ink set of the present invention may be prepared by mixing each of the aforementioned components with water appropriately, by a method well known per se, such as stirring.

Each ink composition that constitutes the ink set of the present invention includes at least one or more types of dye as the coloring matter, water, and the water-soluble organic solvent in the total mass thereof. It is preferred that the each ink composition further include a pH-adjusting agent in addition to the aforementioned components.

The content of each component in the total mass of each ink composition will be described below; all of these are given on a mass basis.

The content of the dye contained as a coloring matter is typically 0.5 to 10%, and preferably 2 to 6%.

In addition, the proportion of the water-soluble organic solvent contained is typically 1 to 50%, and preferably 5 to 40%.

The remainder other than the aforementioned components is water.

In addition, when the pH-adjusting agent, preferably triethanolamine, is further included, the proportion thereof may be similar to the amount described above.

Preferably a nonionic surfactant and a preservative fungicide may be included as the other agents for preparing inks that may be included in the each ink composition. When these components are included, the proportion in total is 0 to 10%, and preferably 0.05 to 5%, based on the total mass of the ink composition.

Each ink composition that constitutes the ink set of the present invention is obtained by mixing as necessary the aforementioned components, respectively, and stirring the mixture until the solid contents such as the dye are dissolved. When used in inkjet textile printing, it is preferred to use each ink composition from which contaminants have been removed by filtering with a membrane filter or the like. The pore size of the membrane filter is typically 1 to 0.1 μm, and preferably 0.5 to 0.1 μm.

In addition, the type of the water-soluble organic solvent and agents for preparing inks contained in the ink composition may each be selected independently from the above illustrative examples, but it is preferable to use the same components. Moreover, the content of the coloring agent, the water-soluble organic solvent, agents for preparing inks, and the like in each ink composition are not necessarily the same for each color, but it is preferable to adjust properly the contents in view of the viscosity and the like of the composition, depending on the properties and the like of the coloring agent included.

The colored material of the present invention means a substance colored by the ink set of the present invention. The material of the colored material is not particularly limited, and may be any that can be colored onto, for example, communication sheets such as papers and films, fibers as well as cloths (cellulose, nylon, wool, and the like), leathers, substrates for color filters, and the like, but is not limited thereto. An ink jet recording method in which an ink jet printer is used may be employed as the coloring method.

### EXAMPLES

Hereinafter, the present invention will be described in detail by way of Examples, but the present invention is not in any way limited to the following Examples. In the Examples, unless otherwise specifically stated, the term “part” means “part by mass” and “%” means “% by mass,” respectively.

### Example 1

### Synthesis Example

54.4 parts of 96.5% sulfuric acid was added to a reactor, and 48.4 parts of 32.5% fuming sulfuric acid was added thereto under ice cooling to prepare 7% fuming sulfuric acid. Subsequently, 15.2 parts of anthrapyridone compound represented by the above formula (1) was slowly added while ice cooling was performed at 20° C. or below, and then was sulfonated at a temperature of 15 to 20° C. for 4 hours. The reaction solution was added to 400 parts of ice water, and then 25 parts of sodium chloride was added thereto under stirring. Then, after 1 hour of stirring, the resulting solution was filtered and isolated, and then washed with 20 parts of 10% aqueous sodium chloride solution. Then the wet cake was stirred with 300 parts of water for 30 minutes, and filtered to filter out and isolate a small quantity of insoluble substances. 30 parts of sodium chloride was added to the mother liquid under stirring to permit salting out. After stirring for 1 hour, the resulting mother liquid was filtered, isolated, and dried to obtain a coloring mixture having, as a main component, disulfonic acid body of anthrapyridone compound represented by the above formula (1) as a red powder. It was found from an analysis thereof through high-performance liquid chromatography (HPLC) that the content of disulfonic acid body of the compound represented by the above formula (1) was 89% and that the content of monosulfonic acid body of the compound represented by the above formula (1) was 7% as an area ratio.

The red powder was stirred in methanol of 5 times the mass at room temperature for 1 hour, filtered, washed with methanol, and dried to obtain 15.6 parts of sodium salt of anthrapyridone sulfonic acid having a very small quantity of an inorganic salt as a red crystal (λmax=533 nm: in water). It was found from an analysis thereof through high-performance liquid chromatography (HPLC) that the content of disulfonic acid body of the compound represented by the above formula (1) was 96% and that the content of monosulfonic acid body of the compound represented by the above formula (1) was 0.3% as an area ratio.

Then, after an ink composition was obtained by mixing the dyes at a composition ratio listed in the following Table 2 and stirring the mixture for about 1 hour until the solid contents were dissolved; the resulting solution was filtered through a 0.45-μm membrane filter (trade name Cellulose Acetate Filter Paper, manufactured by Advantec Toyo Kaisha, Ltd.) to prepare the ink composition for tests. In addition, the ink sets of the combinations disclosed in Examples 2 to 5 were produced by using the ink composition.

TABLE 2

| Ink Composition | Composition ratio | |
|---|---|---|
| dye | X | parts |
| glycerin | 5.0 | parts |
| urea | 5.0 | parts |
| 2-pyrrolidone | 4.0 | parts |
| isopropyl alcohol | 3.0 | parts |
| butylcarbitol | 2.0 | parts |
| Surfynol 440 | 0.1 | parts |
| sodium hydroxide + water | remainder | |
| Total | 100.0 | parts |

### Example 2

Magenta: Compound of Example 1 (X=4.0 parts)

Yellow: C.I. Direct Yellow 132 (X=4.0 parts)

### Example 3

Magenta: Compound of Example 1 (X=4.0 parts)

Yellow: C.I. Direct Yellow 132 (X=3.0 parts)
: C.I. Acid Yellow 110 (X=1.0 part) Total X=4.0 parts

### Example 4

Magenta: Compound of Example 1 (X=4.0 parts)

Yellow: C.I. Direct Yellow 132 (X=2.0 parts)
: C.I. Acid Yellow 110 (X=2.0 parts) Total X=4.0 parts

As Comparative Examples 1 and 2, the dyes for the Comparative Examples were mixed similarly to Examples 2 to 4 at a composition ratio listed in Table 2 and the ink sets of the Comparative Examples were obtained by a similar method.

### Comparative Example 1

Magenta: C.I. Direct Red 227 (X=4.0 parts)

Yellow: C.I. Direct Yellow 86 (X=4.0 parts)

### Comparative Example 2

Magenta: C.I. Acid Red 52 (X=4.0 parts)

Yellow: C.I. Direct Yellow 86 (X=4.0 parts)

### Inkjet Printing

Inkjet recording was carried out by using an inkjet printer (trade name: PIXUS ip4100, manufactured by Canon, Inc.) onto two types of premium plain paper listed in Table 3. During inkjet recording, a checked pattern (a pattern generated by alternatively combining 1.5-mm angle squares with concentrations of 100% and 0%) was produced to obtain yellow/white, orange/white, and magenta/white printed matters, each having high contrast. When a visual assessment was made of a water-resistance test, the printed matters having the checked pattern were used. Various methods for evaluating a recorded image and methods for evaluating the test results will be described below. In addition, when light resistance was tested, an image pattern was produced and the printed matters having each of the colors were obtained such that the reflection density was obtained at several tonal gradations.

TABLE 3
Premium plain paper 1: OKH-JOFF70 (Manufactured by OJI PAPER CO.,
LTD.)
Premium plain paper 2: Ziegler Z-plot 650 (Manufactured by Ziegler Ltd.)

By using each of the printed images obtained with the inks prepared from Examples 2 to 4 and Comparative Examples 1 and 2, evaluations of water resistance, light resistance, and changes in image concentration before and after testing were made.

### (1) Test of Water Resistance

0.3 mL of ion-exchanged water was added dropwise to printed matters with a checked pattern that had been dried for 24 hours after printing. After natural drying of the water drops, the state of discoloration of a colored part of the pattern and the state of coloration of a white part were evaluated with the naked eye, and were rated for three phases based on the following criteria.

A: There is no blurring

C: There is a little blurring, but most of the colored parts remained

E: There is serious blurring, and the color comes out

The results of the premium plain paper 1 are listed in Table 4 and the results of the premium plain paper 2 are listed in Table 5.

### (2) Test of Light Resistance

A low-temperature xenon weather meter XL75, trade name, manufactured by Suga test Instruments Co., Ltd, was used to irradiate each of the printed images for 24 hours (short-term light resistance) and for 96 hours (long-term light resistance) under conditions of 100,000-lux illumination, 60% humidity RH, and 24° C. temperature. Then the colors were measured by using a colorimeter, and the residual values for the coloring matters of each image were calculated by using the equation: (reflected density after testing/reflected density before testing)×100(%). The test results were evaluated against the following criteria. The change in the concentration of the printed image was determined by colorimetric measurement, using a colorimeter, trade name SpectroEye, manufactured by GRETAG-MACBETH AG, of the gradational part having the value D of reflected density of the printed image before testing that was closest to 1.0.

S: Residual rate: 85% or more

A: Residual rate: 75% or more and less than 85%

B: Residual rate: 65% or more and less than 75%

C: Residual rate: 55% or more and less than 65%

D: Residual rate: 45% or more and less than 55%

E Residual rate: less than 45%

The results for the premium plain paper 1 are listed in Table 6 and the results for the premium plain paper 2 are listed in Table 7.

TABLE 4
Result of water-resistance test (Premium plain paper 1)

| | Yellow part | Orange part | Magenta part |
|---|---|---|---|
| Example 2 | E | C | A |
| Example 3 | C | A | A |
| Example 4 | A | A | A |
| Comparative Example 1 | E | E | E |
| Comparative Example 2 | E | E | E |

TABLE 5
Result of water-resistance test (Premium plain paper 2)

| | Yellow part | Orange part | Magenta part |
|---|---|---|---|
| Example 2 | A | A | A |
| Example 3 | A | A | A |
| Example 4 | A | A | A |
| Comparative Example 1 | A | A | C |
| Comparative Example 2 | A | C | E |

TABLE 6
Result of light-resistance test (Premium plain paper 1)

| | |
|---|---|
| Yellow part | Magenta part |

24 hours: short-term

| | | |
|---|---|---|
| Example 2 | S | S |
| Comparative Example 1 | A | D |

96 hours: long-term

| | | |
|---|---|---|
| Example 2 | C | B |
| Comparative Example 1 | C | E |

TABLE 7
Result of light-resistance test (Premium plain paper 2)

| | |
|---|---|
| Yellow part | Magenta part |

24 hours: short-term

| | | |
|---|---|---|
| Example 2 | A | A |
| Comparative Example 1 | B | E |
| Comparative Example 2 | B | D |

96 hours: long-term

| | | |
|---|---|---|
| Example 2 | C | C |
| Comparative Example 1 | C | E |
| Comparative Example 2 | C | E |

It was clearly found from the results in Tables 4 and 5 that the magenta part in each of the Comparative Examples exhibited blurring in the water-resistance test of the premium plain paper 1, thereby not yielding a good result. In contrast, the magenta parts of Examples 2 to 4 did not exhibit blurring even in water-resistance tests of two types of premium plain papers, thereby yielding very good results.

Similarly, the yellow parts in each of the Comparative Examples exhibited blurring in the water-resistance test of the premium plain paper 1, thereby not yielding good results. In contrast, the yellow parts of Examples 2 to 4 exhibited good results in the premium plain paper 2 and nearly good results in the premium plain paper 1, excluding Example 2.

In addition, the orange parts that are the mixed parts of yellow and magenta in each of the Comparative Examples exhibited blurring in the premium plain paper 1, thereby not yielding a good result. In contrast, the orange parts of Examples 2 to 4 exhibited good results even in water-resistance testing of any single type of the two types of premium plain papers, thereby yielding very good results.

From the foregoing results, it was confirmed that the ink sets of the Examples of the present invention can form images having excellent water resistance in the hue range of yellow-orange-magenta, as compared with each Comparative Example.

In addition, it was clearly found from the results in Tables 6 and 7 that the ink set of Example 2 exhibited good results under both short-term and long-term conditions, as compared with all the Comparative Examples for a light-resistance test of two types of premium plain papers. In addition, it was found that the ink set of Example 2 had a small difference between the residual rates of yellow and magenta and excellent balance of light resistances for each of the dyes under all conditions.

From the foregoing results, it was confirmed that the ink set according to the Example of the present invention can form images having excellent light resistance in the hue range of yellow-magenta, as compared with all the Comparative Examples.

### INDUSTRIAL APPLICABILITY

The ink set for an inkjet according to the present invention can provide printed matters having excellent water resistance and light resistance, particularly in the hue range of yellow-orange-magenta.

1. An ink set for inkjet recording, comprising two ink compositions, each of a different color, of a) a magenta-ink composition and b) a yellow-ink composition, each including a dye, water, and a water-soluble organic solvent,
wherein the magenta-ink composition a) includes a compound obtained by sulfonating a compound represented by the following formula (1), a salt thereof, or a mixture thereof as a coloring agent:

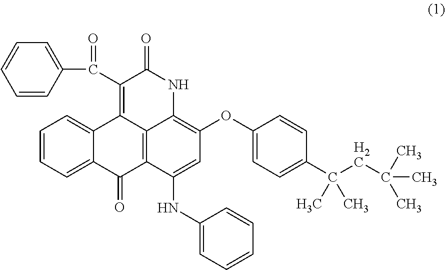 [SMILES: CC(C)(C)CC(C)(C)c1ccc(Oc2cc(Nc3ccccc3)c3c4c(c(C(=O)c5ccccc5)c(=O)[nH]c24)-c2ccccc2C3=O)cc1]

2. The ink set for inkjet recording according to claim 1, wherein the magenta-ink composition a) includes a compound represented by the following formula (2), a salt thereof, or a mixture thereof as a coloring agent:

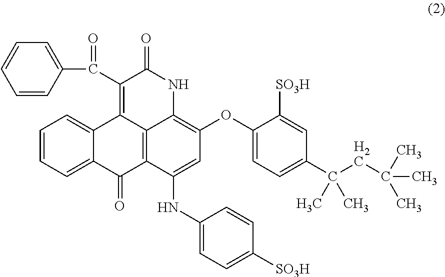 [SMILES: CC(C)(C)CC(C)(C)c1ccc(Oc2cc(Nc3ccc(S(=O)(=O)O)cc3)c3c4c(c(C(=O)c5ccccc5)c(=O)[nH]c24)-c2ccccc2C3=O)c(S(=O)(=O)O)c1]

3. The ink set for inkjet recording according to claim 2, wherein the content of the compound represented by the formula (2), the salt thereof, or the mixture thereof is 80% by mass or more in the coloring agent of the magenta-ink composition a).

4. The ink set for inkjet recording according to claim 1, wherein the yellow-ink composition b) includes C.I. Direct Yellow 132 as a coloring agent.

5. The ink set for inkjet recording according to claim 1, wherein the yellow-ink composition b) includes C.I. Acid Yellow 110 as a coloring agent.

6. The ink set for inkjet recording according to claim 1, wherein the yellow-ink composition b) includes both C.I. Direct Yellow 132 and C.I. Acid Yellow 110 as coloring agents.

7. The ink set for inkjet recording according to claim 6, wherein the blend ratio of C.I. Direct Yellow 132 to C.I. Acid Yellow 110 as coloring agents included in the yellow-ink composition b) is 30/70 to 90/10 by mass.

8. The ink set for inkjet recording according to claim 6, wherein the blend ratio of C.I. Direct Yellow 132 to C.I. Acid Yellow 110 as coloring agents included in the yellow-ink composition b) is 40/60 to 60/40 by mass.

9. The ink set for inkjet recording according to claim 1, wherein the total content of the coloring agent is 0.5 to 10% by mass in the total mass of the magenta-ink composition a) and the total content of the coloring agent is 0.5 to 10% by mass in the total mass of the yellow-ink composition b).

10. The ink set for inkjet recording according to claim 1, wherein the total content of the coloring agent is 2 to 6% by mass in the total mass of the magenta-ink composition a) and the total content of the coloring agent is 2 to 6% by mass in the total mass of the yellow-ink composition b).

11. An inkjet recording method, comprising recording using the ink set for inkjet recording according to claim 1, and discharging ink droplets of each ink of the ink set in response to recording signals to make the droplets adhere to a record-receiving material.

12. The inkjet recording method according to claim 11, wherein the record-receiving material is a communication sheet.

13. A colored material obtained by coloring with the ink set for inkjet recording according to claim 1.

14. The colored material according to claim 13, wherein the coloring is carried out using an inkjet printer.

15. An inkjet printer equipped with a vessel including each ink composition included in the ink set for inkjet recording according to claim 1.
